(19) United States
(12) Patent Application Publication
(10) Pub. No.: US 2015/0149349 A1
(43) Pub. Date: May 28, 2015

(54) REDEEMABLE CODE TO TEXT

(71) Applicant: BOKU. INC., San Francisco, CA (US)

(72) Inventor: Adam Lee, Burlingame, CA (US)

(73) Assignee: BOKU. INC., San Francisco, CA (US)

(21) Appl. No.: 14/091,129

(22) Filed: Nov. 26, 2013

(51) Int. Cl. G06Q 20/10; G06Q 20/40

(52) U.S. Cl. CPC G06Q 20/102; G06Q 20/40
USPC 705/40

(57) ABSTRACT

A method and system of processing a sale of an article, a virtual article, a service or a functionality such as a game is described. A code is generated by a server. A charge request is transmitted to an account server to charge an account of a user for a value of the code. The code is transmitted to a user device. The code is then processed by redeeming the code, wherein redemption of the code includes receiving the code from a user device and in response allowing access to the user device to the article, virtual article, a service or a functionality.

### BACKGROUND OF THE INVENTION

1). Field of the Invention

This invention relates to a method and system for processing a sale of an article, a virtual article, a service or a functionality such as a game using redeemable codes.

2). Discussion of Related Art

A merchant who sells articles, virtual articles, services or functionalities such as access to games online usually have an online store and a check-out system, wherein the online store can be used by remote user to select an item for purchase and the checkout system allows for the user to enter payment details such as credit card details or the like. Instead of direct payment, the merchant may offer the sale of a unique code that can be redeemed for the user to obtain access to the item. Many of these codes are purchased by users and gifted to other users. However, it is also common for people such as minors who do not have credit cards to purchase codes over the counter using cash and then use these codes themselves. Systems and methods are required that will allow for merchants to more easily sell codes to users.

### SUMMARY OF THE INVENTION

The invention provides a method of processing a sale of an article, a virtual article, a service, or a functionality including receiving, with a billing server, a first text message from the user device, the first text message being a request for a code and transmitting, with the billing server, the code to a user device of the user, redemption of the code allowing access to the user device to the article, virtual article, service, or functionality.

The invention also provides a method of processing a sale of an article, a virtual article, a service, or a functionality including receiving, with a billing server, a request for a code from a user, identifying, with the billing server, a carrier server of the user from a plurality of carrier servers, receiving, with the billing server, a phone number of the user, an account being an account identified by the phone number on the carrier server, transmitting, with the billing server, a charge request to the carrier server to charge an account of a user corresponding to the phone number for a value of a code and transmitting, with the at least one server, the code to a user device of the user, redemption of the code allowing access to the user device to the article, virtual article, service, or functionality.

The invention further provides a non-transitory computer readable medium having stored thereon a set of instructions which, when executed by at least one processor, performs a method of processing a sale of an article, a virtual article, a service, or a functionality including receiving, with a billing server, a first text message from the user device, the first text message being a request for a code, transmitting, with a billing server, a charge request to an account server to charge an account of a user for a value of a code and transmitting, with the billing server, the code to a user device of the user, redemption of the code allowing access to the user device to the article, virtual article, service, or functionality.

The invention further provides a billing server including a processor, a computer-readable medium connected to the processor, a network interface device connected to the processor and a set of instructions on the computer-readable medium being executable by the processor to carry out a method for processing a sale of an article, a virtual article, a service, or a functionality including a text messaging module receiving a first text message from the user device, the first text message being a request for a code and a code management module transmitting the code to a user device of the user, redemption of the code allowing access to the user device to the article, virtual article, service, or functionality.

The invention also provides a method of processing a sale of an article, a virtual article, a service, or a functionality including receiving, with the billing server, a request message from a mobile application running on the user device, the request message being a request for a code, transmitting, with billing server, a charge request to an account server to charge an account of a user for a value of the code, the charge request being in response to the request message and transmitting, with the billing server, the code to a user device of the user.

The invention further provides a billing server including a processor, a computer-readable medium connected to the processor, a network interface device connected to the processor and a set of instructions on the computer-readable medium being executable by the processor to carry out a method for processing a sale of an article, a virtual article, a service, or a functionality including a mobile application communication module receiving a request message from a mobile application running on the user device, the request message being a request for a code, a billing module transmitting a charge request to an account server to charge an account of a user for a value of the code, the charge request being in response to the request message and a code management module transmitting the code to a user device of the user.

The invention also provides a method of processing a sale of an article, a virtual article, a service, or a functionality including receiving, with the billing server, a phone number and a code from a merchant server, transmitting, with billing server, a charge request to an account server to charge an account of a user for a value of the code, the charge request being in response to receiving the phone number at the billing server and transmitting, with the billing server, the code to a user device of the user.

The invention further provides a billing server including a processor, a computer-readable medium connected to the processor, a network interface device connected to the processor and a set of instructions on the computer-readable medium being executable by the processor to carry out a method for processing a sale of an article, a virtual article, a service, or a functionality including a billing server application programmable interface receiving a phone number and a code from a merchant server, a billing module transmitting a charge request to an account server to charge an account of a user for a value of the code, the charge request being in response to receiving the phone number at the billing server and a code management module transmitting the code to a user device of the user.

The invention also provides a method of processing a sale of an article, a virtual article, a service, or a functionality including receiving, with a billing server, a request message via a payment panel of the billing server on a website of a merchant server, the request message including a phone number and being a request for a code, transmitting, with billing server, a charge request to an account server to charge an account of a user for a value of the code, the charge request being in response to the request message and transmitting, with the billing server, the code to a user device of the user.

The invention further provides a billing server including a processor, a computer-readable medium connected to the processor, a network interface device connected to the processor and a set of instructions on the computer-readable medium being executable by the processor to carry out a method for processing a sale of an article, a virtual article, a service, or a functionality including a payment panel communication module receiving a request message via a payment panel of the billing server on a website of a merchant server, the request message including a phone number and being a request for a code, a billing module transmitting a charge request to an account server to charge an account of a user for a value of the code, the charge request being in response to the request message and a code management module transmitting the code to a user device of the user.

### BRIEF DESCRIPTION OF THE DRAWINGS

The invention is further described by way of example with reference to the accompanying drawings, wherein:

FIG. 1 illustrates a method of processing a sale of an article, a virtual article, a service, or a functionality such as a game using codes;

FIG. 2 is a view of a user device in the form of a user mobile phone that is used to carry out the method of FIG. 1;

FIG. 3 is a view similar to FIG. 2 wherein a code is redeemed by a user;

FIG. 4 is a block diagram of a network environment within which the method of FIG. 1 can operate;

FIG. 5 is a block diagram illustrating how a charge can be placed on a carrier server other than in a direct billing arrangement;

FIG. 6 is a view similar to FIG. 1 illustrating a method according to another embodiment of the invention;

FIG. 7A is a view of a user mobile phone that is used to carry out the method of FIG. 6, in particular illustrating text messages;

FIG. 7B is a view of the user mobile phone in FIG. 7A wherein a redeemable code is received in an email;

FIG. 8 is a view similar to FIG. 1 illustrating a method according to a further embodiment of the invention;

FIG. 9 is a view similar to FIG. 1 illustrating a method according to yet a further embodiment of the invention;

FIGS. 10A and 10B are views similar to FIG. 1 illustrating a method according to a further embodiment of the invention;

FIGS. 11A and 11B are views similar to FIG. 1 illustrating a further embodiment of the invention;

FIG. 12 is a block diagram of a network environment according to another embodiment of the invention;

FIG. 13 is a view similar to FIG. 1 illustrating a method according to yet a further embodiment of the invention wherein the network environment of FIG. 12 is used;

FIG. 14 is a view of display of a user mobile phone having a mobile application for use within the network environment and method of FIGS. 12 and 13;

FIG. 15 is a block diagram of a network environment similar to FIG. 14 according to a further embodiment of the invention;

FIG. 16 is a view similar to FIG. 1 illustrating a further embodiment of the invention wherein the network environment of FIG. 15 is used;

FIG. 17 is a display of a mobile website on a user mobile phone for use within the network environment and method of FIGS. 15 and 16;

FIG. 18 is a block diagram of a network environment similar to FIG. 4 according to a further embodiment of the invention;

FIG. 19 is a view similar to FIG. 1 of a method according to a further embodiment of the invention wherein the network environment of FIG. 18 is used;

FIG. 20 is a view of merchant website with a payment panel that allows communication directly between a user mobile phone and a billing server;

FIG. 21 is a block diagram of the user mobile phone illustrating SmartPhone features thereof; and

FIG. 22 is a block diagram of a machine in the form of a computer system forming part of the processing system.

### DETAILED DESCRIPTION OF THE INVENTION

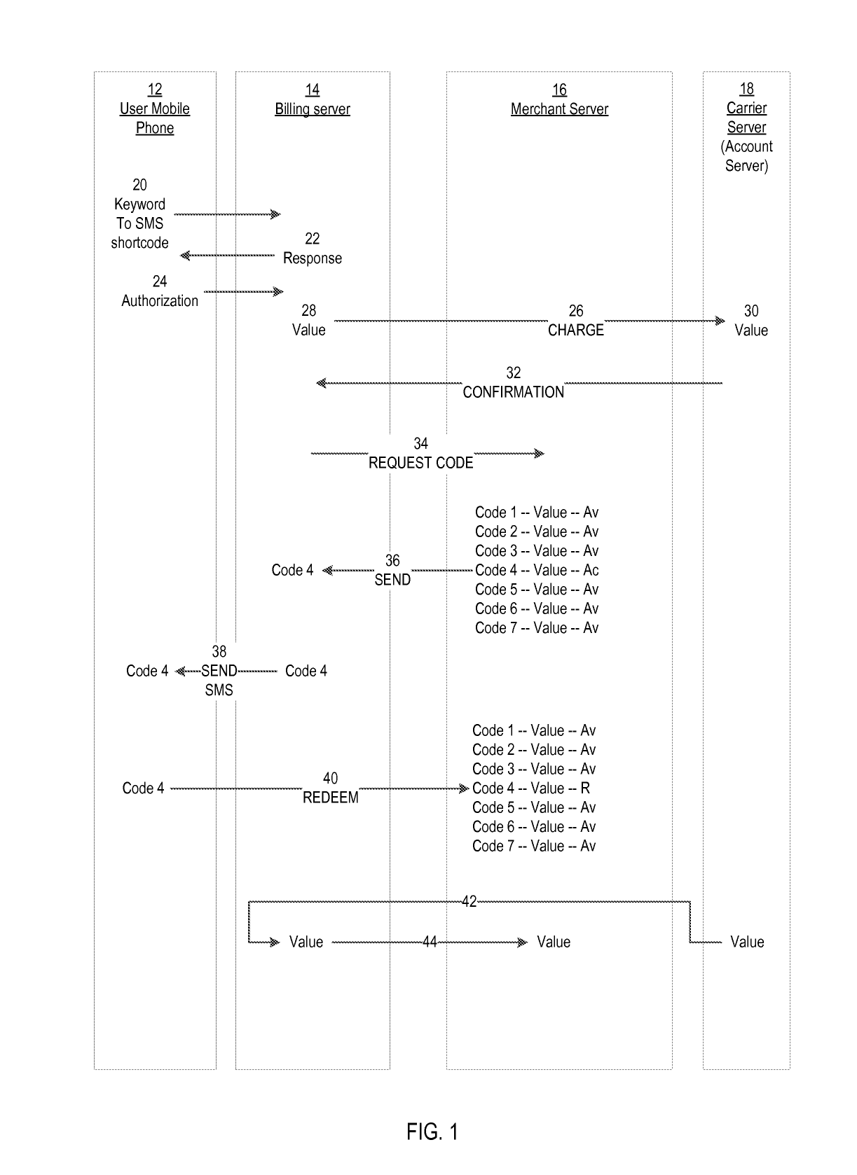

FIG. 1 of the accompanying drawings illustrates a method, according to an embodiment of the invention, of processing a sale of an article, a virtual article, a service or functionality such as a game. The method is carried out in a system environment that includes a user mobile phone 12, a billing server 14, a merchant server 16, and a carrier server 18 serving as an account server.

At 20, a user uses the user mobile phone 12 to send a first text message to the billing server 14. The first text message includes a keyword and is transmitted to a Short Message Server (SMS) shortcode so that it is received at the billing server 14. The phone number of the user mobile phone 12 is appended to the text message so that the billing server 14 can identify the phone number of the user mobile phone 12. Although not shown in the figure, it should be understood that the first text message travels through the carrier server 18 before reaching the billing server 14. The carrier server 18 appends their identity to the first text message so that the billing server 14 can identify the carrier server 18 from a plurality of different carrier servers.

If the keyword is correctly entered and matches a keyword that has been registered at the billing server 14, the billing server 14 at 22 transmits a second text message to the user mobile phone 12 in response to the first text message transmitted at 20. The second text message requests an authorization to charge an account of the user mobile phone 12 on the carrier server 18. The second text message transmitted at 22 again traverses the carrier server 18 before reaching the user mobile phone 12.

At 24, the user of the user mobile phone 12 transmits a third text message to the billing server 14. The third text message indicates either authorization or not authorization. If the text message 24 does not authorize the transaction, then no charge is placed on an account at the carrier server 18 and no code is transmitted to the user mobile phone 12.

If the third text message 24 does includes an authorization, the billing server 14 proceeds, at 26, to transmit a charge request to the carrier server 18. The particular carrier server 18 has been identified from the first text message 20 and the charge request 26 is transmitted to the relevant carrier server 18. The charge request 26 includes a phone number and a value 28 stored in the billing server 14. The carrier server 18 then charges an account on the carrier server 18 corresponding to the phone number for an amount having a value 30 corresponding to the value 28. In the present embodiment, the value 28 is determined from the particular keyword transmitted in the first text message 20. For example, if the keyword is “argo25”, then the billing server 14 matches the particular keyword to a particular value of for example $25. The particular value is then the value 28 that is transmitted in the charge request 26. If the carrier server 18 successfully places a charge on the account of the user, then, the carrier server 18 automatically transmits a confirmation 32 indicating that the account has been charged. The billing server 14 receives the confirmation 32 and then at 34 requests a code from the merchant server 16 in response to the receipt of the confirmation 32.

The merchant server 16, in the present embodiment, has a plurality of codes (codes 1 to 7). Each code has a respective value. Each code initially indicates that it is available (Av). The merchant server 16 at 36 sends or transmits one of the codes, in the present example code 4, to the billing server 14. The merchant server 16 also marks the relevant code as active (Ac). An active code differentiates from an available code in that that active code has been sent and is available for redemption. The billing server 14 receives the code from the merchant server 16 and then automatically at 38 sends or transmits the code to the user mobile phone 12.

At 40, a user of the user mobile phone 12 redeems the code at the merchant server 16. The merchant server 16 then marks the relevant code as redeemed (R). Each code can only be redeemed once. When the merchant server processes the redemption of the code, the merchant server 16 also allows access to the user mobile phone 12 to the article, virtual article, service, or functionality such as a game.

What has been described is the sale of one of the codes within the merchant server 16. The process can be repeated until all the codes within the merchant server 16 have been sold. When all the codes have been sold, the merchant server 16 may again mark all the codes as available, or may create a new set of codes for purposes of selling to users.

At a later time, the carrier server 18 collects an amount corresponding to or based on the value 30 from the user. The carrier server 18 typically collects the money when the user pays their phone bill. At 42, the carrier server 18 pays the billing server 14 for an amount corresponding to the value. At 44, the billing server 14 passes an amount on to the merchant server 16 based on the value. The carrier server 18 and the billing server 14 will typically hold back a portion of the money received from the user such that the final amount that is paid to the merchant server 16 is slightly less than, but still based on the original value 30.

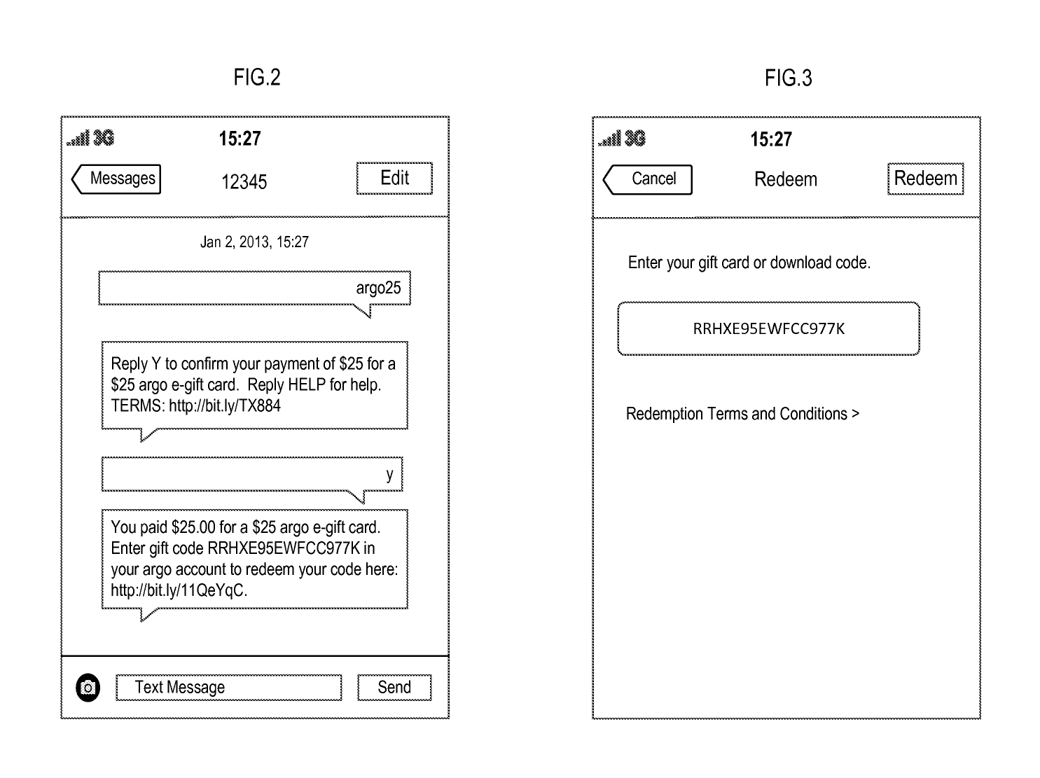

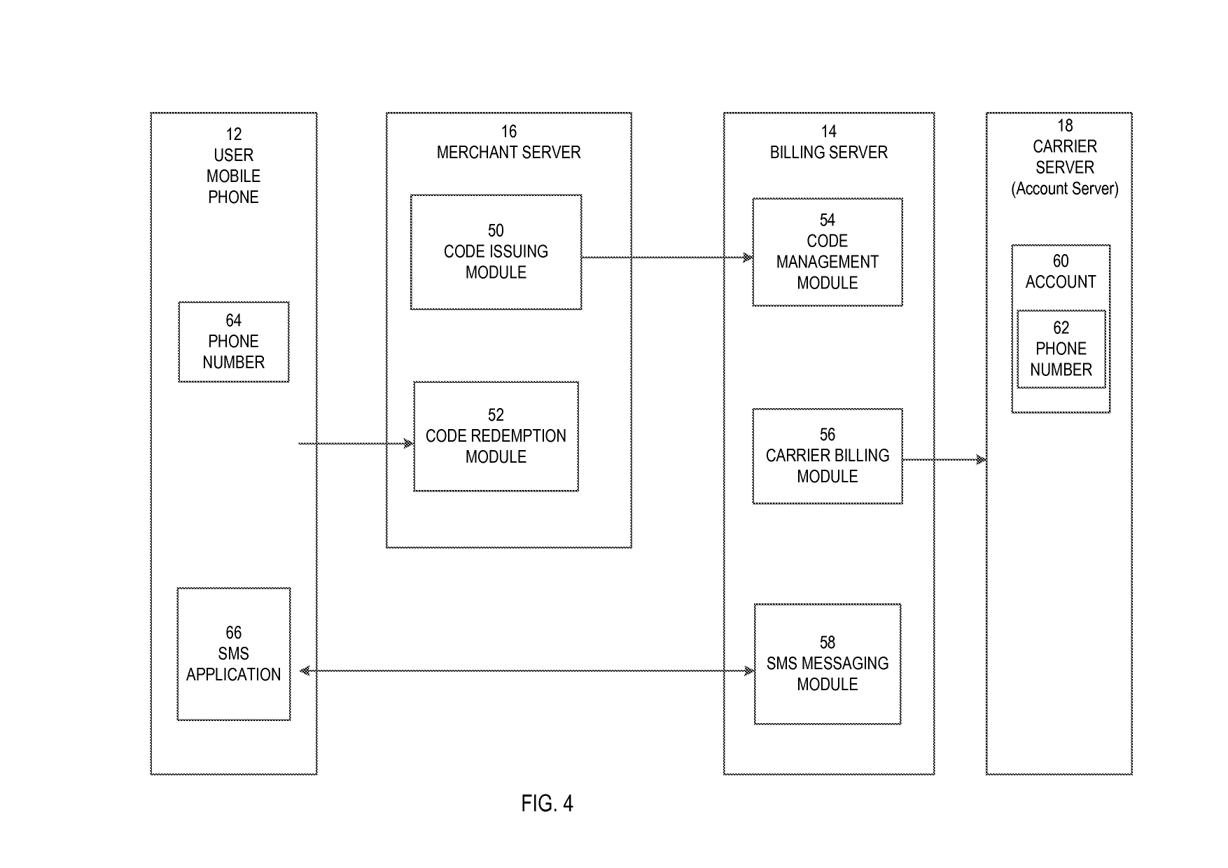

FIG. 2 illustrates a view of the user mobile phone 12 wherein the text messages that are transmitted at 20, 22, 24 and 36 in FIG. 1 are displayed. FIG. 3 illustrates a view of the user mobile phone 12 wherein the consumer enters the code received in the last text message shown in FIG. 2 for purposes of redeeming the code.

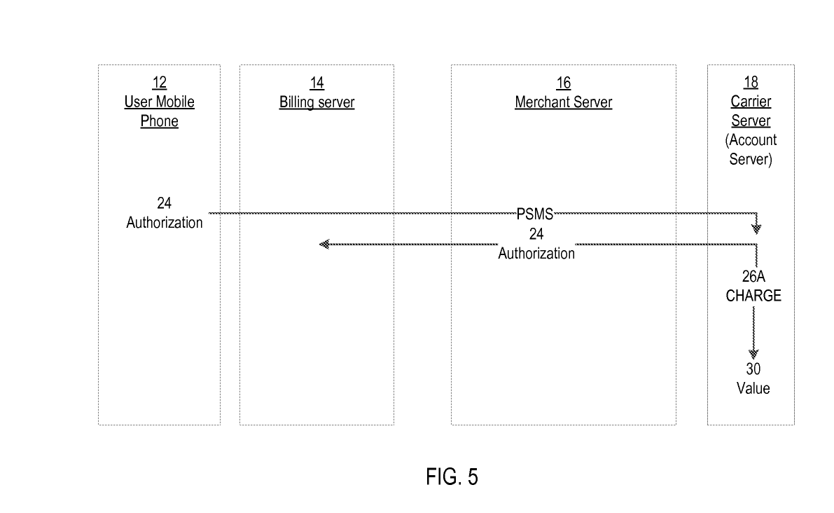

FIG. 4 shows the network environment of FIG. 1 in more detail. The merchant server 16 has a code issuing module 50 and a code redemption module 52. The billing server 14 has a code management module 54, a carrier billing module 56 and an SMS messaging module 58. The carrier server 18 has a plurality of accounts 60, each identified by a phone number 62. The user mobile phone 12 has a phone number 64 stored in memory in an SMS application 66. The SMS messaging module 58 is a text messaging module that receives text messages from and sends text messages to the user mobile phone 12. The SMS application 66 is used by the user to send and receive text messages. The carrier billing module 56 is used to transmit a charge request to the carrier server 18 to charge the account 60 of the user having the phone number 62 for the value of the code. The code management module 54 requests a code from the code issuing module 50 and is used to transmit the code to the user mobile phone 12 via the SMS messaging module 58. The code redemption module 52 is used to redeem the code at the merchant server 16 and allow access to the user mobile phone 12 to the article, virtual article, service or functionality such as a game.

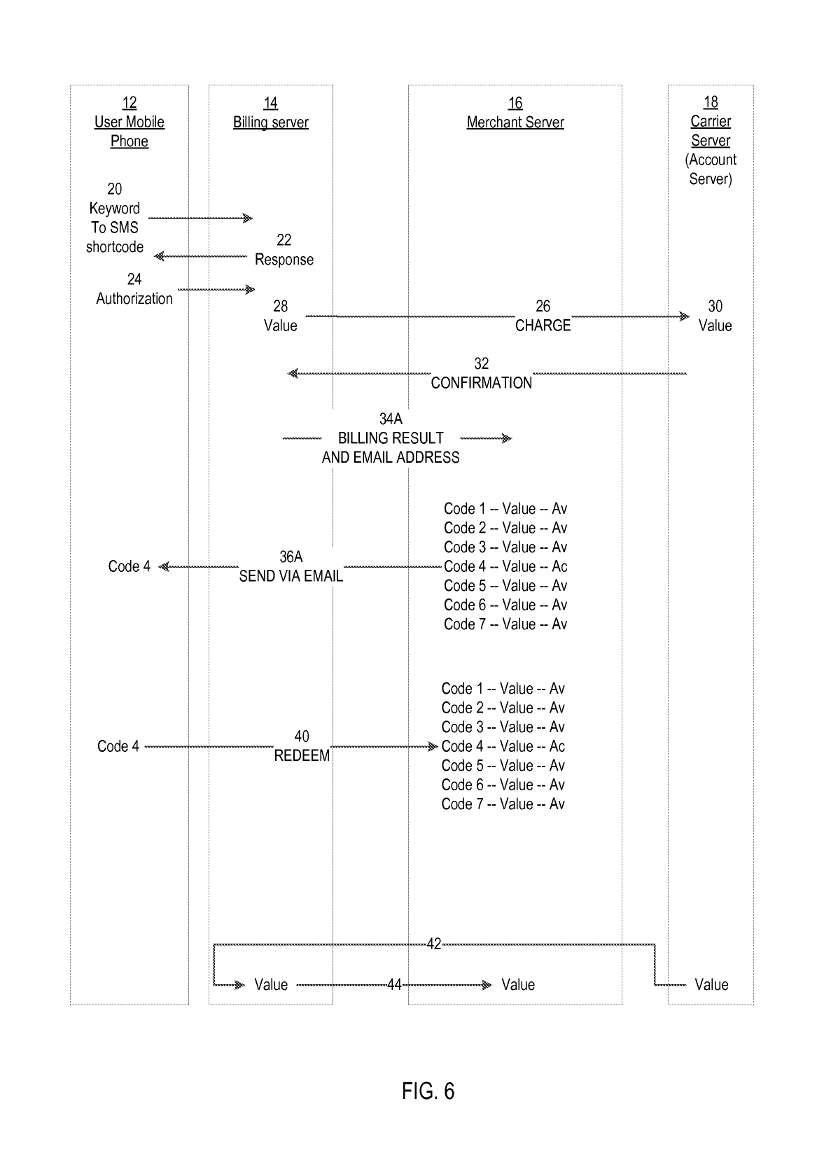

As mentioned with respect to FIG. 1, the SMS text messages that are transmitted at 20, 22, 24 and 38 all travel through a network of the carrier server 18. Each one of the text messages can be used as a premium SMS (PSMS) billing event instead of the charge request at 26 in FIG. 1. FIG. 5 for example illustrates how the authorization step 24 can be a PSMS event. The authorization text message is transmitted through a network of the carrier server 18 before being forwarded by the carrier server 18 to the billing server 14. At 26A, the carrier server 18 records a charge for the value 30 based on the PSMS that was transmitted.

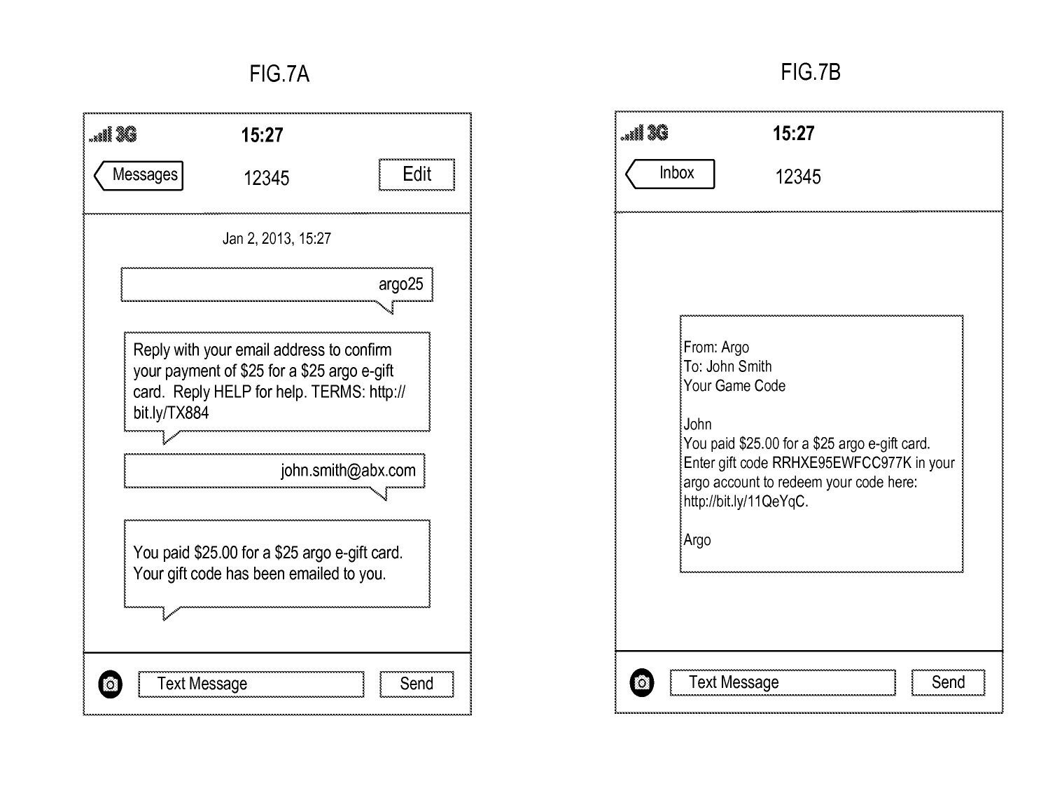

FIG. 6 illustrates an alternate embodiment of the invention. FIG. 6 is similar to FIG. 1 and like reference numerals indicates like systems or processes. At 22, the response requests that the user enter an email address where the code should be transmitted to. At 24, the user responds with an authorization and an email address. At 34A, the billing server 14 transmits the billing result and the email address of the user to the merchant server 16. The billing result is transmitted immediately and automatically following the confirmation 32. The billing server 14 thus does not request a code from the merchant server 16 at 34A as opposed to the code request in 34 in FIG. 1.

At 36A, the merchant server 16 sends the code directly to the user mobile phone 12 via email using the email address received at 34A. The billing server 14 is thus not used for receiving the code or for sending the code to the user mobile phone 12.

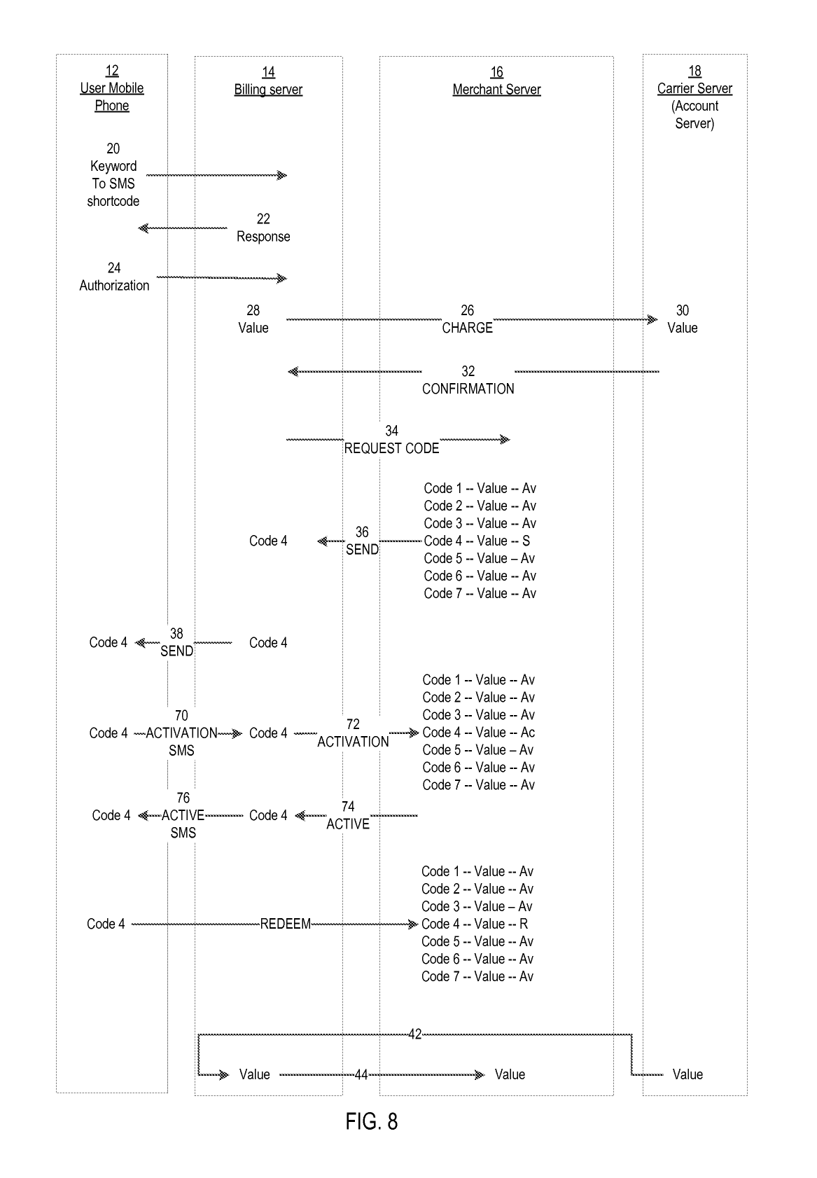

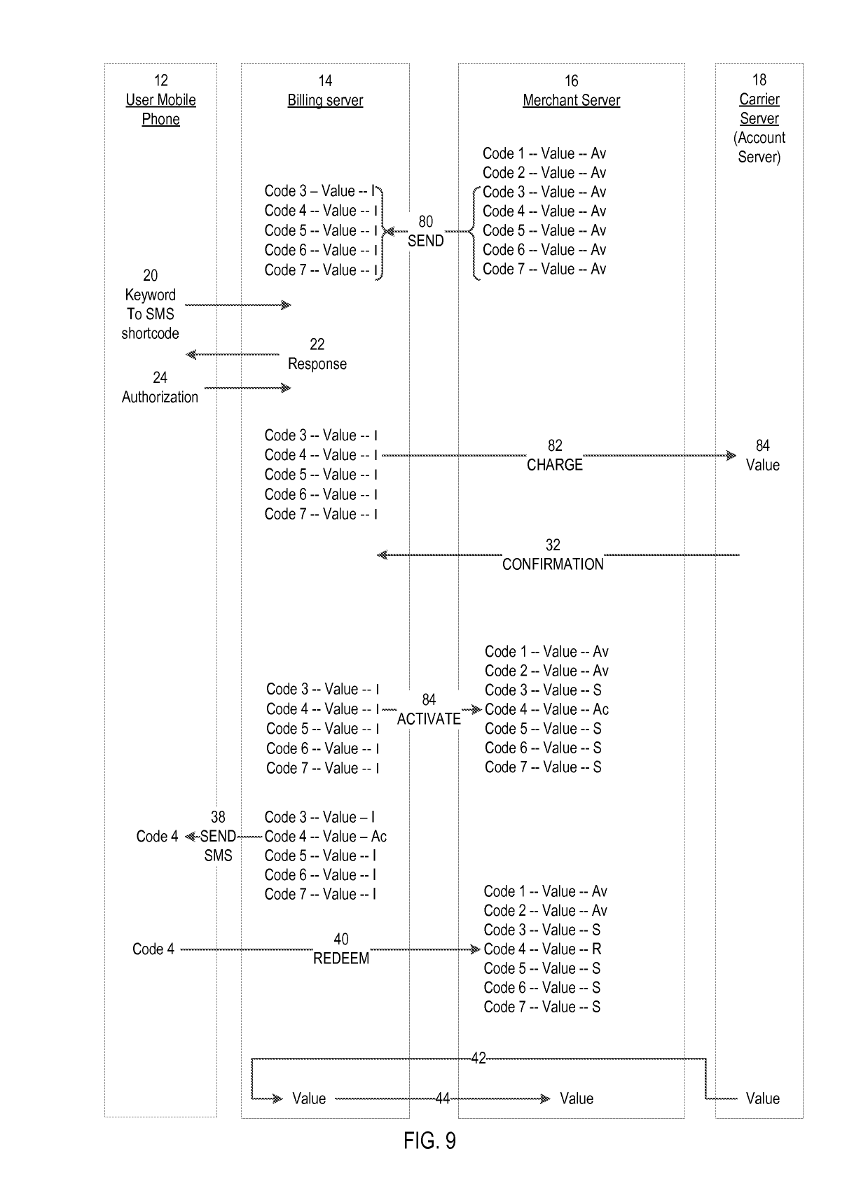

FIG. 7A illustrates how the text messages are exchanged. Instead of replying “Y” in FIG. 2, in FIG. 7A the user responds with an email address. Instead of providing a redeemable code as in FIG. 2, in FIG. 7A the user is informed by the billing server 14 that the redeemable code is emailed to the email address. FIG. 7B illustrates an email that is received by the user mobile phone 12 from the merchant server 16, including the redeemable code.

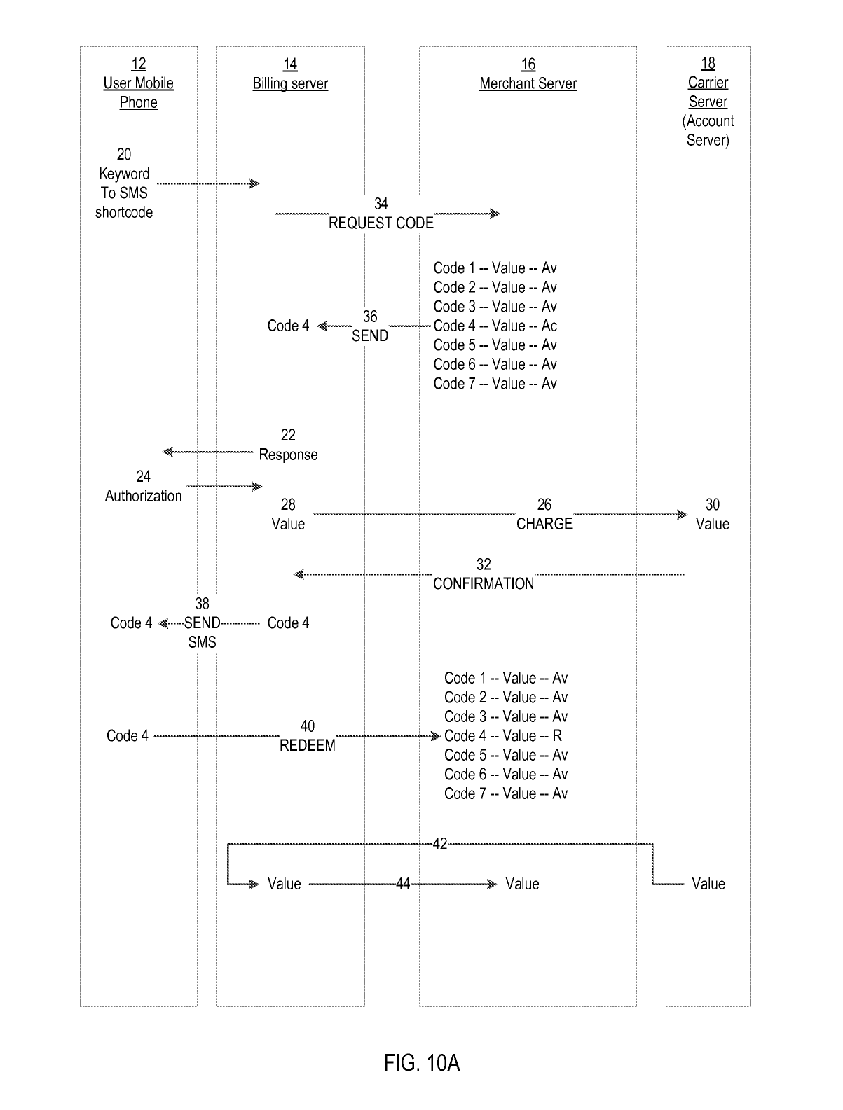

FIG. 8 illustrates a further embodiment that is similar to the embodiment in FIG. 1 and wherein like reference numerals indicate like systems or processes. At 36, the code is sent to the billing server 14, but the code is not marked as active. The code is only marked at sent (S). Until the code is marked at active it is not redeemable. At 38, the billing server 14 sends the code to the user mobile phone 12. At 70, the user uses the user mobile phone 12 to send an activation request to the billing server 14. The activation request 70 is typically a reply to the text message that is sent at 38. The billing server 14 at 72 sends an activation request to the merchant server 16. The merchant server 16 then marks the code as active, whereafter it is redeemable. At 74, the merchant server 16 sends a confirmation to the billing server 14 that the code is active. At 76, the billing server 14 sends an SMS text message to the user mobile phone 12 indicating that the code is active.

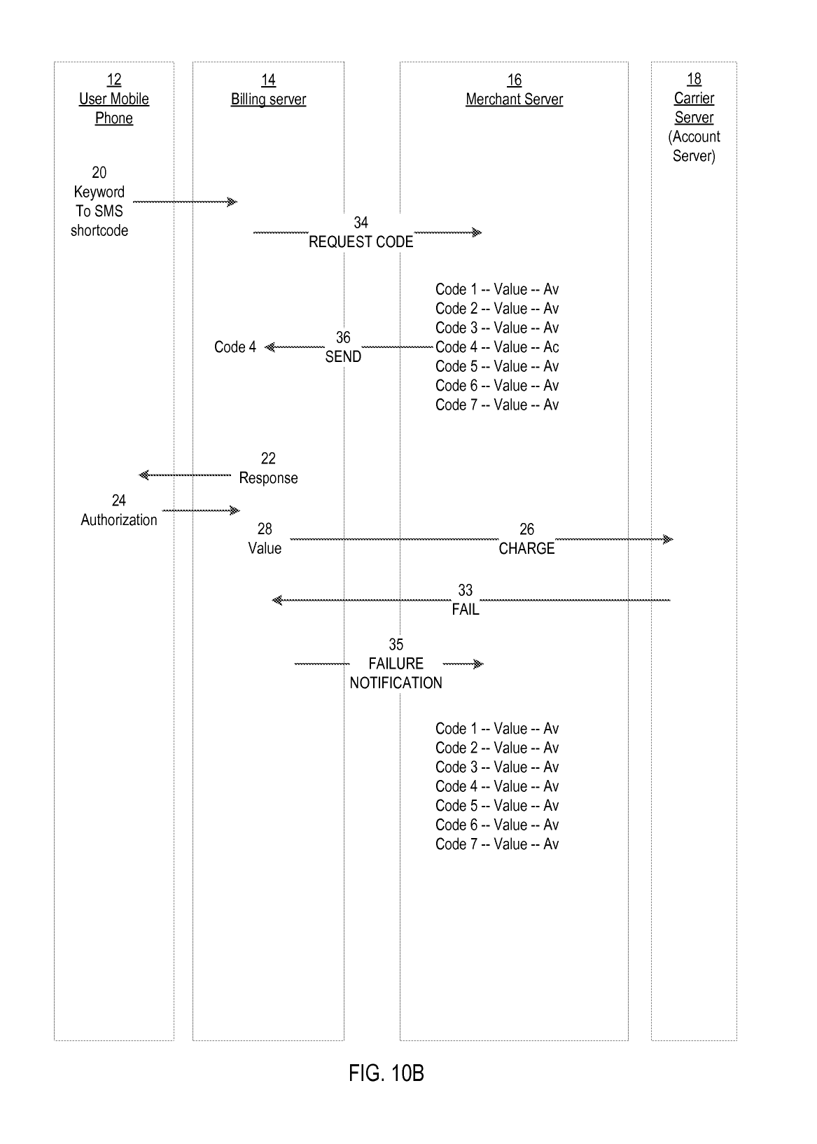

In the embodiment in FIG. 1 the code is sent at 36 after the confirmation 32 of the charge. FIG. 9 illustrates an embodiment where the code is sent before confirmation 32 of the charge. At 80, the merchant server 16 transmits a subset of codes to the billing server 14. All the codes within the merchant server 16 are still marked as available. After the merchant server 16 has sent the subset of codes to the billing server 14 the subset of codes are marked as sent at the merchant server 16 and inactive (I) at the billing server 14. The user then at 20 transmits a keyword to the billing server 14 as part of a first text message to a shortcode of the billing server 14. At 22, the billing server 14 sends a second text message to the user mobile phone 12 requesting authorization of the charge. At 24, the user mobile phone 12 sends an authorization to the billing server 14 in a third text message. At 82, the billing server 14 attempts to place a charge on the carrier server 18. The codes that have been received by the billing server 14 each have a respective value associated therewith. The charge that is placed on the carrier server 18 is for a value 84 corresponding to the value of one of the codes, in the present example the value corresponding to code 4. At 32, the carrier server 18 confirms that the charge has been placed.

At 84, the billing server 14 sends an activation request to the merchant server 16. The merchant server 16 then marks the relevant code as active. At 38, the billing server 14 then sends a fourth SMS message to the user mobile phone 12 with the relevant code. The billing server 14 also removes the code that has been sent to the user mobile phone 12 from the subset of codes that were received from the merchant server 16 at 80. As such, the billing server 14 will not resend the same code to the user mobile phone 12 or any other user device.

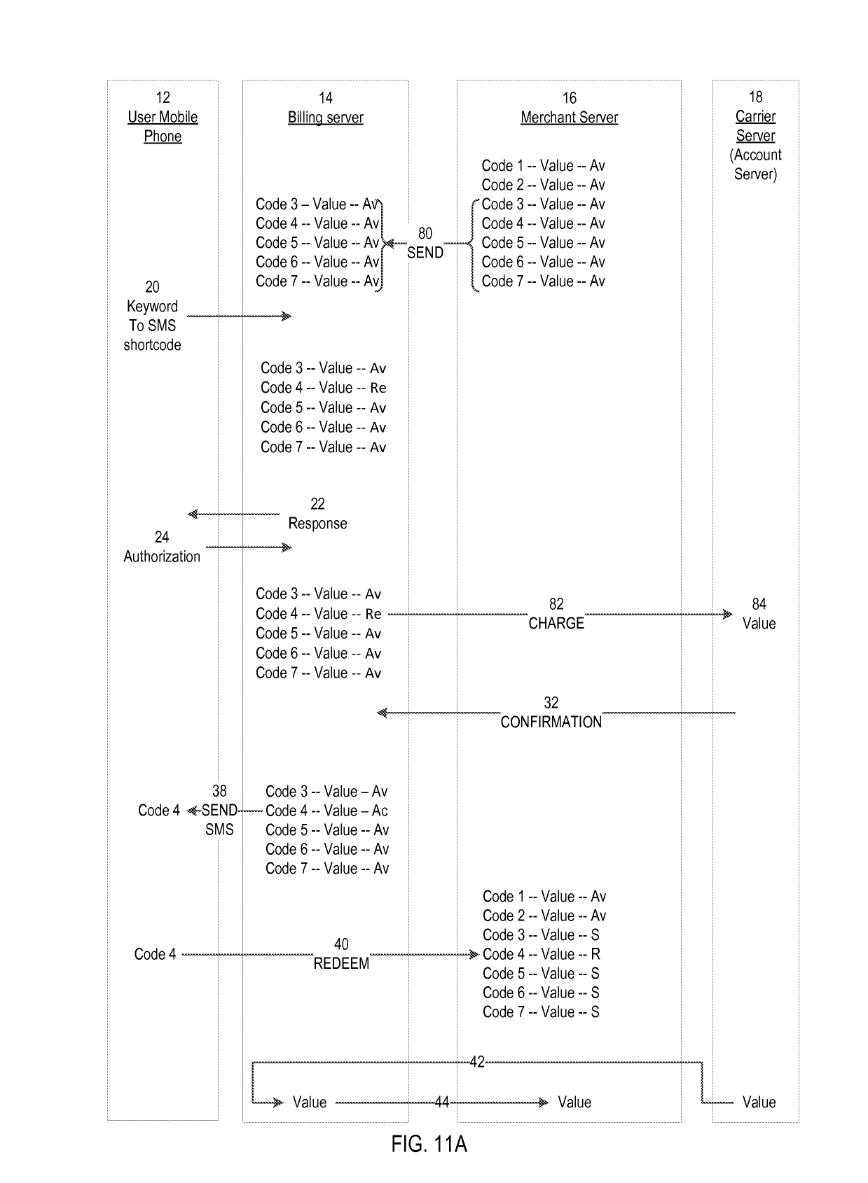

FIG. 10A illustrates a further embodiment wherein a code is received before a charge event. At 20, the user transmits a text message from the user mobile phone 12 to the billing server 14 requesting a code. At 34, the billing server 14 requests a code from the merchant server 16. At 36, the merchant server 16 transmits a code to the billing server 14. At 22, the billing server 14 subsequently, i.e. after receiving the code at 36, requests an authorization from the user mobile phone 12. At 24, the user responds with the user mobile phone 12 to transmit an authorization to the billing server 14. At 26, the billing server 14 attempts to place a charge at the carrier server 18 for the value 28. The carrier server 18 records the value 28 as a value 36 within an account at the carrier server 18. At 32, the carrier server 18 sends a confirmation to the billing server 14. At 38, the billing server 14 transmits the code to the user mobile phone 12. All other steps are similar to FIG. 1 and like reference numerals indicate similar components or steps.

FIG. 10B illustrates what occurs if at 26 the billing server 14 is unable to place a charge at the carrier server 18. At 33, the carrier server 18 transmits a fail notification to the billing server 14. At 35, the billing server transmits a failure notification to the merchant server 16. The merchant server 16 in response to the failure notification 35 by not charging the billing server 14 for the code. The merchant server 16 also marks the code as available.

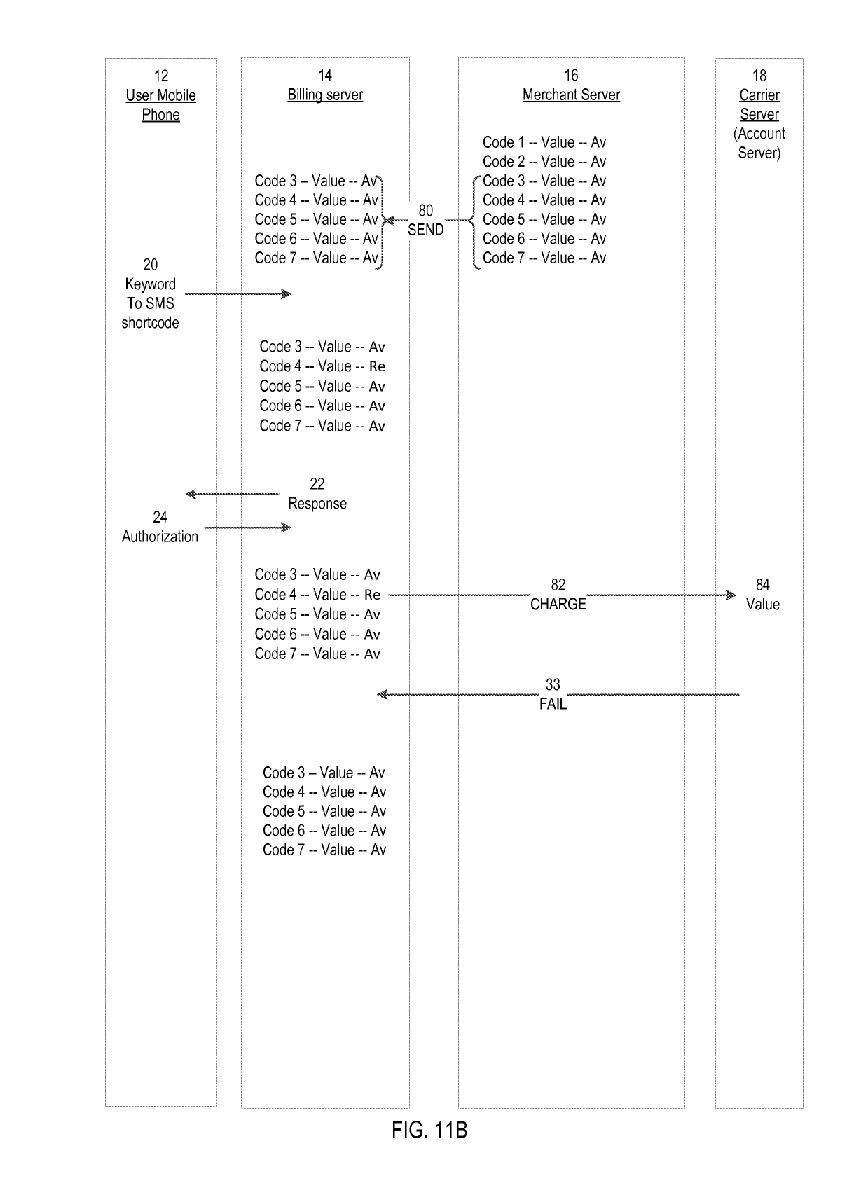

FIG. 11A illustrates an embodiment wherein the billing server 14 marks codes as available, reserved (Re) and activated. At 80, the merchant server 16 sends a subset of codes to the billing server 14. The codes are marked within the billing server 14 as available. When the billing server 14 receives the text message at 20, the billing server 14 marks one of the codes as reserved. Marking the code as reserved ensures that the billing server 14 always has codes available for sale. The billing server 14 responds at 22 by requesting an authorization from the user mobile phone 12. At 24, the user mobile phone 12 provides an authorization to the billing server 14. The billing server 14 responds to the authorization 24 at 82 to attempt to place a charge on the carrier server 18. At 32, the carrier server 18 confirms that the charge has been placed. At 38, the billing server 14 transmits the code to the user mobile phone 12. The billing server 14 also marks the code as active. Once the billing server 14 has marked the code as active, the billing server 14 will not send the same code to any other user device. FIG. 11B illustrates what happens if the charge fails. At 33, the carrier server 18 transmits a fail notification to the billing server 14. The billing server 14 then returns the relevant code to inventory by marking the code that has previously been marked as reserved as again available.

In some of the examples provided the billing server 14 transmits the code to the user mobile phone via SMS. In another example the merchant server 16 transmits the code to the user mobile phone 12 via email without passing through the billing server 14. Modifications of the principle are possible without departing from the scope and spirit of the invention. For example, the billing server 14 may alternatively send the code to the user mobile phone 12 via email or the merchant server may send the code to the user mobile phone 12 via SMS.

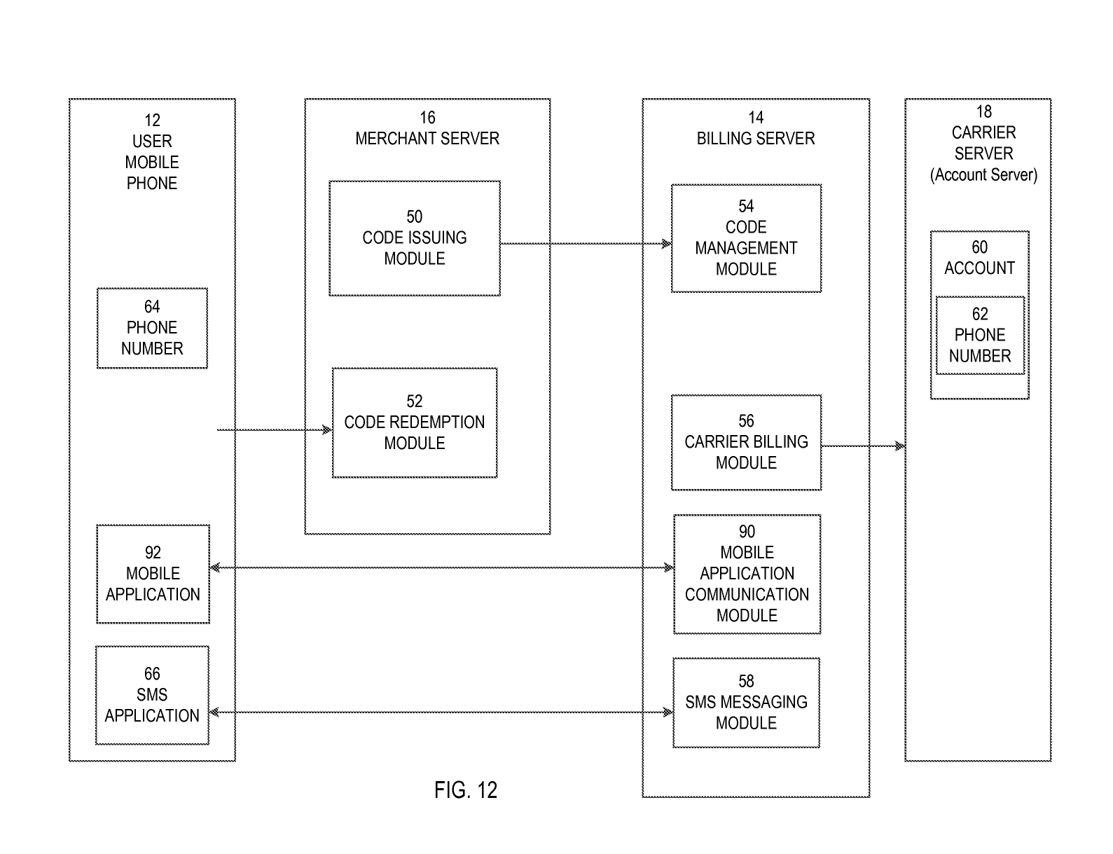

FIG. 12 illustrates a system similar to FIG. 4 wherein the billing server 14 further has a mobile application communication module 90 and the user mobile phone 12 has a mobile application 92. The mobile application 92 has been issued by the merchant server 16 for purposes of making purchases of offers provided by the merchant server 16 as hereinbefore described. The mobile application 92 also communicates directly with the mobile application communication module 90 of the billing server 14. The communication between the mobile application 92 and the mobile application communication module 90 is over the Internet and may include a WiFi network and/or a data telecommunications network.

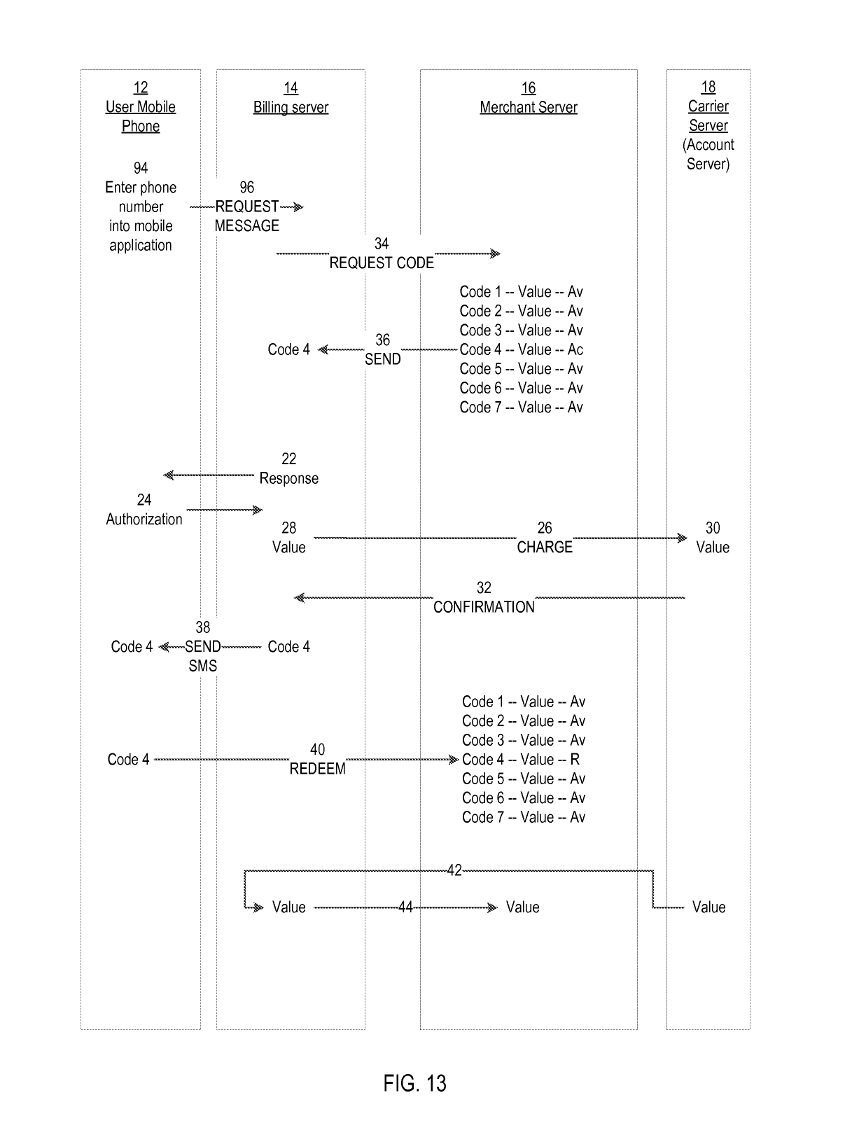

FIG. 13 illustrates the functioning of the system in FIG. 12 in more detail. At 94, a user of the user mobile phone 12 enters a phone number into the mobile application 92. The user then, at 96, transmits a request message from the mobile application 92 running on the user mobile phone 12. The request message transmitted at 96 is a request for a code. At 34, the billing server 14 requests a code from the merchant server 16. The steps starting at 34 in FIG. 13 are the same as the steps starting at 34 in FIG. 10A.

In the example provided in FIG. 13, the billing server 14 places a charge at 26 after receiving the code at 36. Variations of the scheme of synchronizing codes between the billing server 14 and merchant server 16 are contemplated within the scope of the invention, such as hereinbefore described with reference to FIGS. 1, 6, 8, 9, 10A and B, and 11A and B.

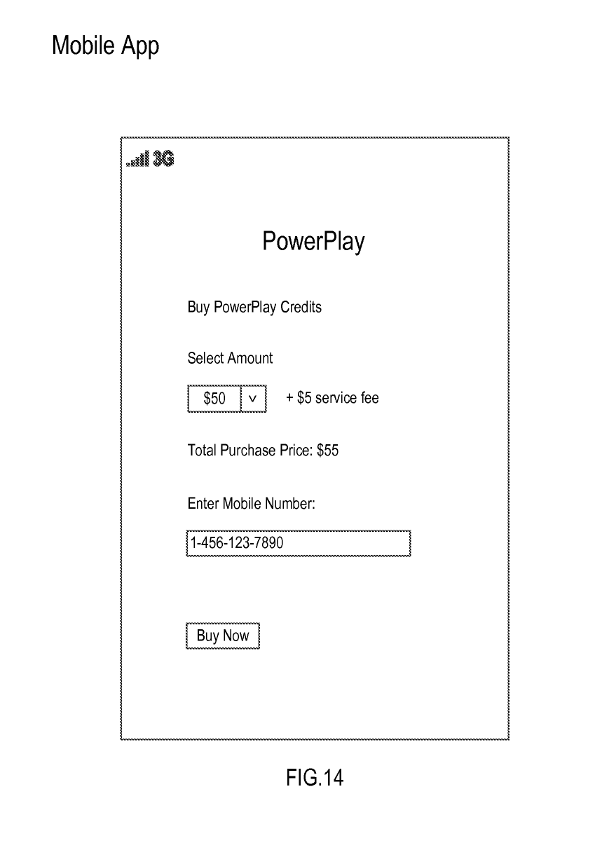

FIG. 14 illustrates a display of the user mobile phone 12 running the mobile application 92 in FIG. 12. The display allows for the user to select a price, in the present example $50. A service fee, in the present example $5, is added to the price selected by the user. The user also enters a mobile phone number. When the user selects the “Buy Now” button, the mobile phone number and price are transmitted by the user mobile phone 12 to the billing server 14 in the request message 96 of FIG. 13.

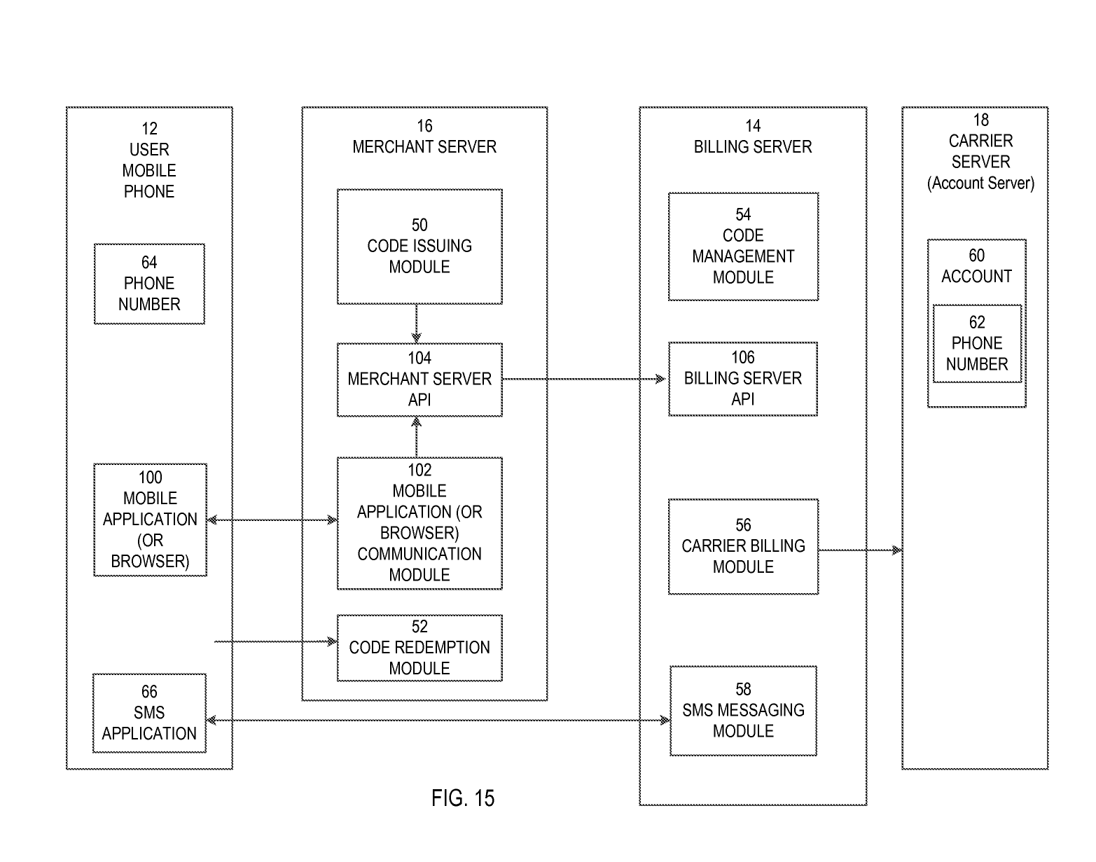

FIG. 15 illustrates a system that is similar to the system in FIG. 4, wherein the user mobile phone 12 includes a mobile application 100, the merchant server 16 includes a mobile application communication module 102 and a merchant server application programmable interface (API) 104 and the billing server 14 includes a billing server API 106.

The mobile application 100 communicates over the Internet with the mobile application communication module 102. The mobile application 100 is used to select purchases for offer on the merchant server 16. The mobile application 100 is also used to make purchases via the merchant server 16. In another embodiment, the mobile application 100 may be replaced with a browser, in which case the mobile application communication module 102 is a browser communication module.

Both the code issuing module 50 and the mobile application communication module 102 are connected to the merchant server API 104. The merchant server API 104 is used to communicate with the billing server API 106. The merchant server API 104 is used to request a charge through the billing server 14 and to synchronize codes between the code issuing module 50 and the code management module 54 on the merchant server 16 and the billing server 14, respectively.

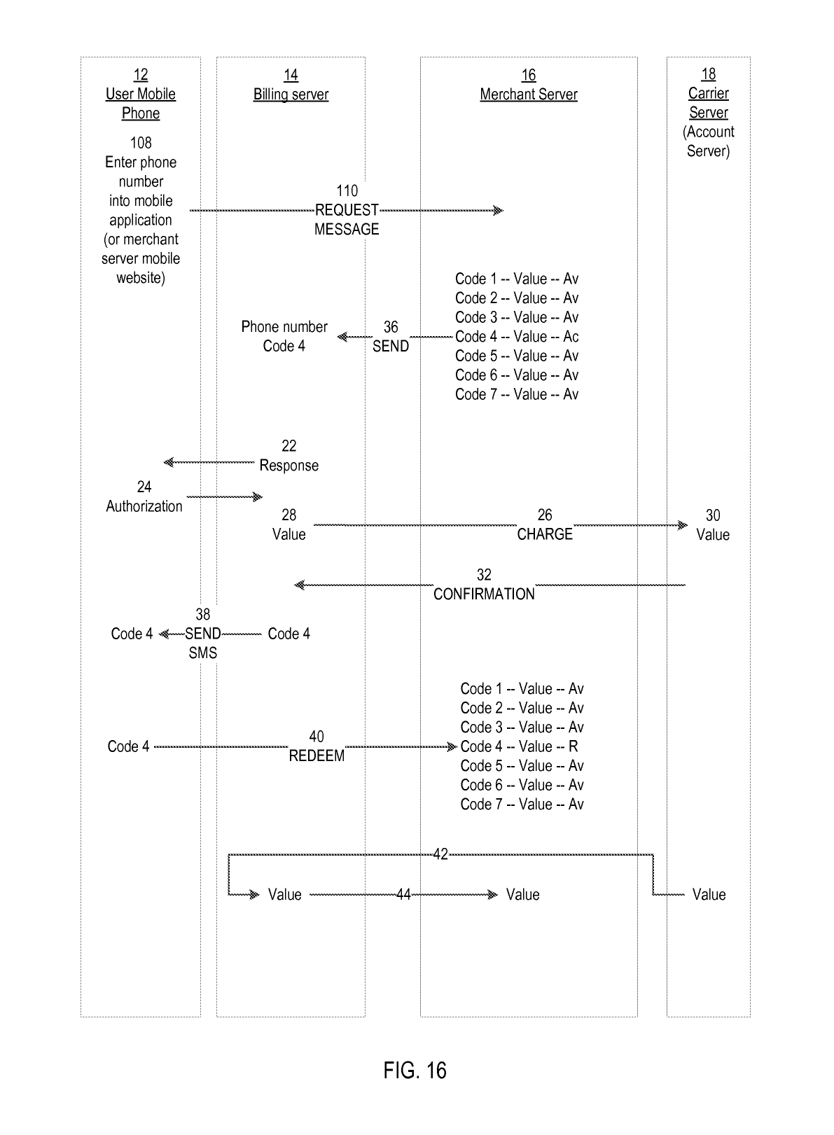

FIG. 16 illustrates the functioning of the system in FIG. 15 in more detail. At 108, a user enters a phone number into the mobile application 100 (or merchant server mobile website) residing on the merchant server 16. At 110, the user mobile phone 12 transmits a request message to the merchant server 16. The request message includes a phone number of the user mobile phone 12.

At 36, the merchant server 16 transmits the phone number of the user mobile phone 12 and a code to the billing server 14. The phone number and the code are typically transmitted together, and typically in the same message. Step 36 in FIG. 16 is thus the same as step 36 in FIG. 10A. Every step starting at step 22 to the end of FIG. 16 are the same as the corresponding steps in FIG. 10A.

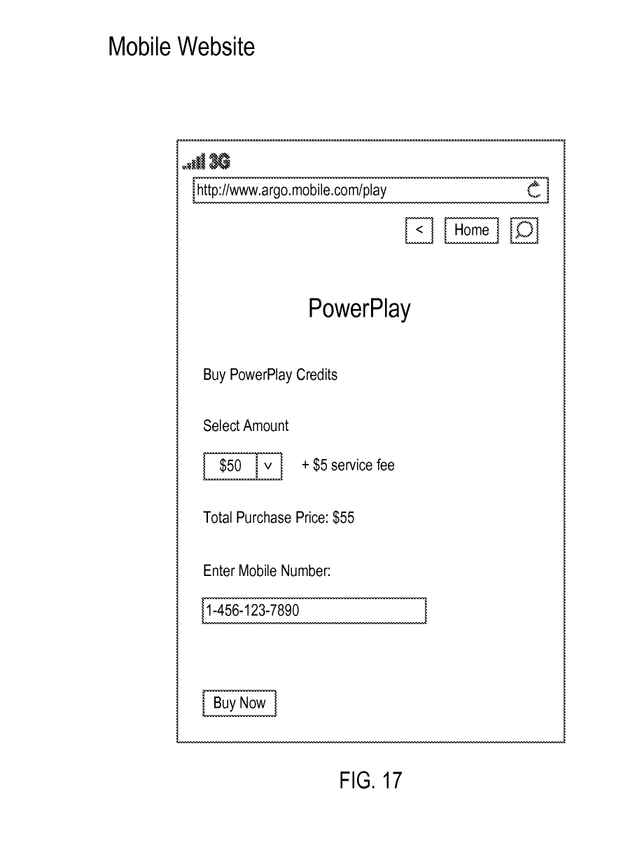

FIG. 17 illustrates a mobile website that may reside on the merchant server 16 of FIG. 16. The user can select a price, in the present example $50. A service fee, in the present example $5, is added to the price selected by the user. The user also enters a mobile phone number. When the user selects the “Buy Now” button, the request message 110 in FIG. 16 is transmitted by the user mobile phone 12 to the merchant server 16.

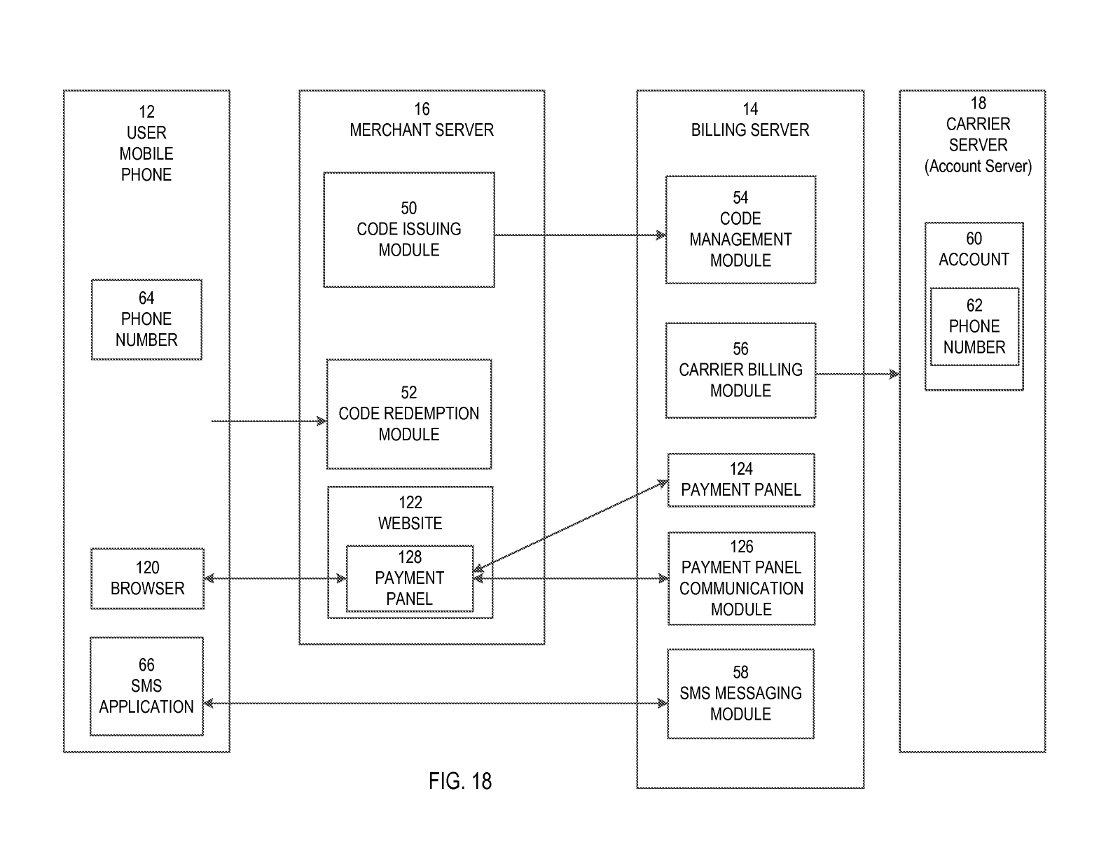

FIG. 18 illustrates a system similar to FIG. 4, wherein the user mobile phone 12 includes a browser 120, the merchant server 16 includes a website 122 and the billing server 14 includes a payment panel 124 and a payment panel communication module 126.

The browser 120 is used by a user to call the website 122 on the merchant server 16. The website 122 on the merchant server 16 transmits a payment panel request to the billing server 14. The billing server 14 responds to the payment panel request by transmitting the payment panel 124 to the website 122. The payment panel 124 is then inserted by the website 122 as a payment panel 128. The merchant server 16 responds to a call from the browser 120 to transmit the website 122 together with a payment panel 128 to the browser 120. A user can then view the website 122 and the payment panel 128 within the browser 120. The user can enter data and interact with the payment panel 128. Such interaction results in communication between the payment panel 128 residing within the browser 120 and the payment panel communication module 126 of the billing server 14 without going through the merchant server 16.

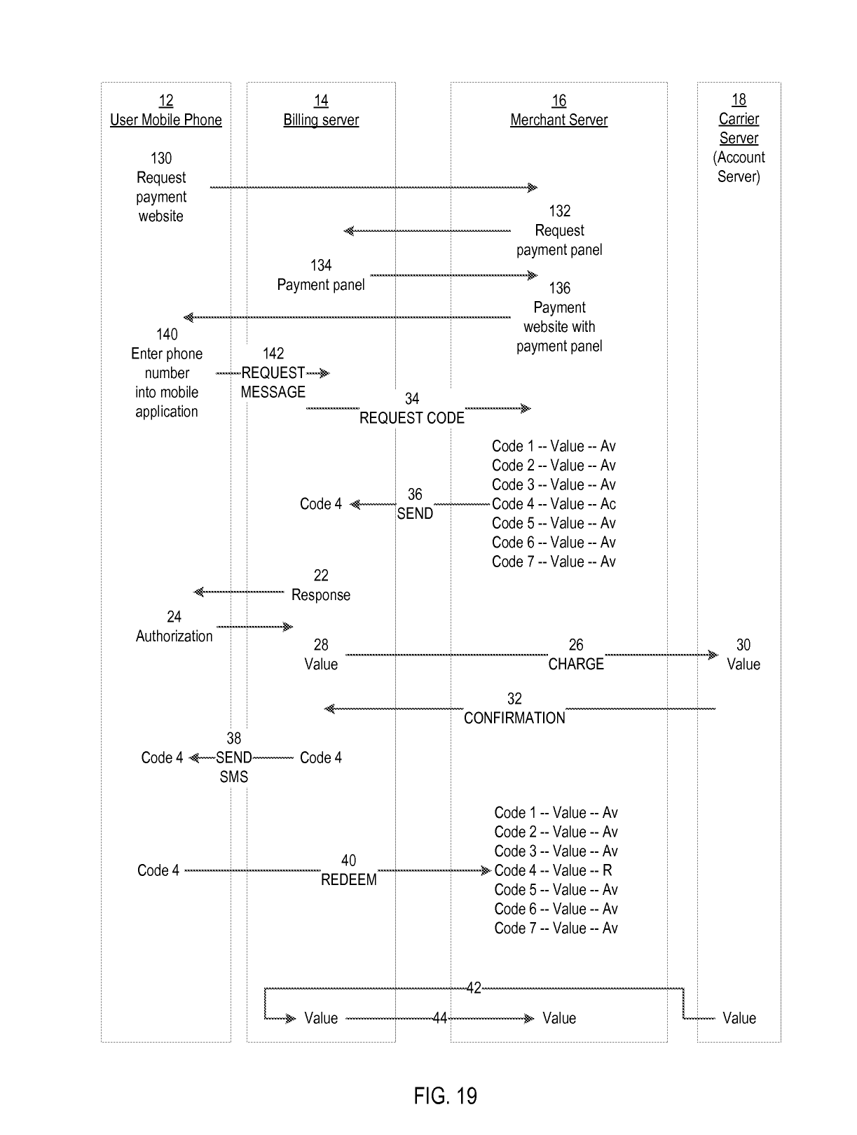

FIG. 19 illustrates the functioning of the system of FIG. 18 in more detail. At 130, the user of the user mobile phone 12 requests a payment website from the merchant server 16. At 132, the merchant server 16 requests a payment panel from the billing server 14. The request for the payment panel at 132 may be in response to the request for the payment website 130, or can be downloaded in advance. At 134, the billing server 14 responds to the request received at 132 to transmit the payment panel to the merchant server 16. At 136, the merchant server 16 responds to the request received at 130 to transmit the website with the payment panel to the user mobile phone 12. At 140, the user of the user mobile phone 12 enters a phone number of the user mobile phone 12 into the mobile application 100. At 142, the user transmits a request message to the billing server 14 without going through the merchant server 16. The request message transmitted at 142 includes the phone number of the user mobile phone 12. Step 34 in FIG. 19 is the same step 34 in FIG. 10A and the remaining steps in FIG. 19 are the same as the remaining steps in FIG. 10A.

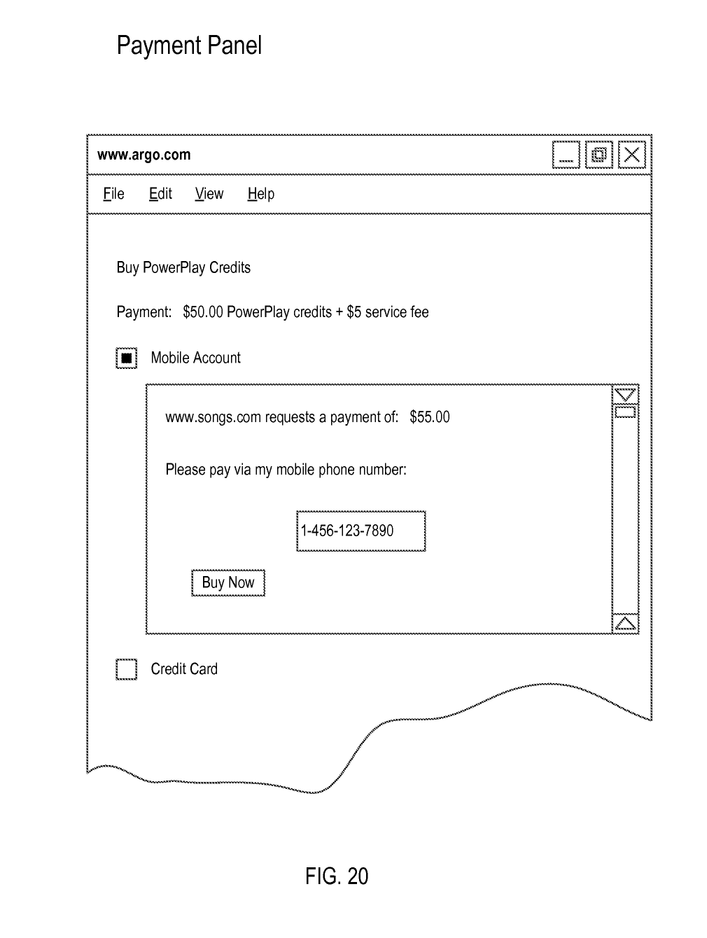

FIG. 20 illustrates a view of the website with the payment panel therein. The website allows for a user to select whether they wish to pay using different means, in the present example by way of a mobile account or by a credit card. The website includes the price, in the present example $50. The website also includes the amount of a service fee, in the present example $5. In the present example, the user has selected to pay by mobile account. Such selection causes the display of the payment panel. The payment panel includes a field where the user can enter the phone number of the user mobile phone 12. When the user selects the “Buy Now” button, the request message 142 in FIG. 19 is transmitted from the user mobile phone 12 to the billing server 14.

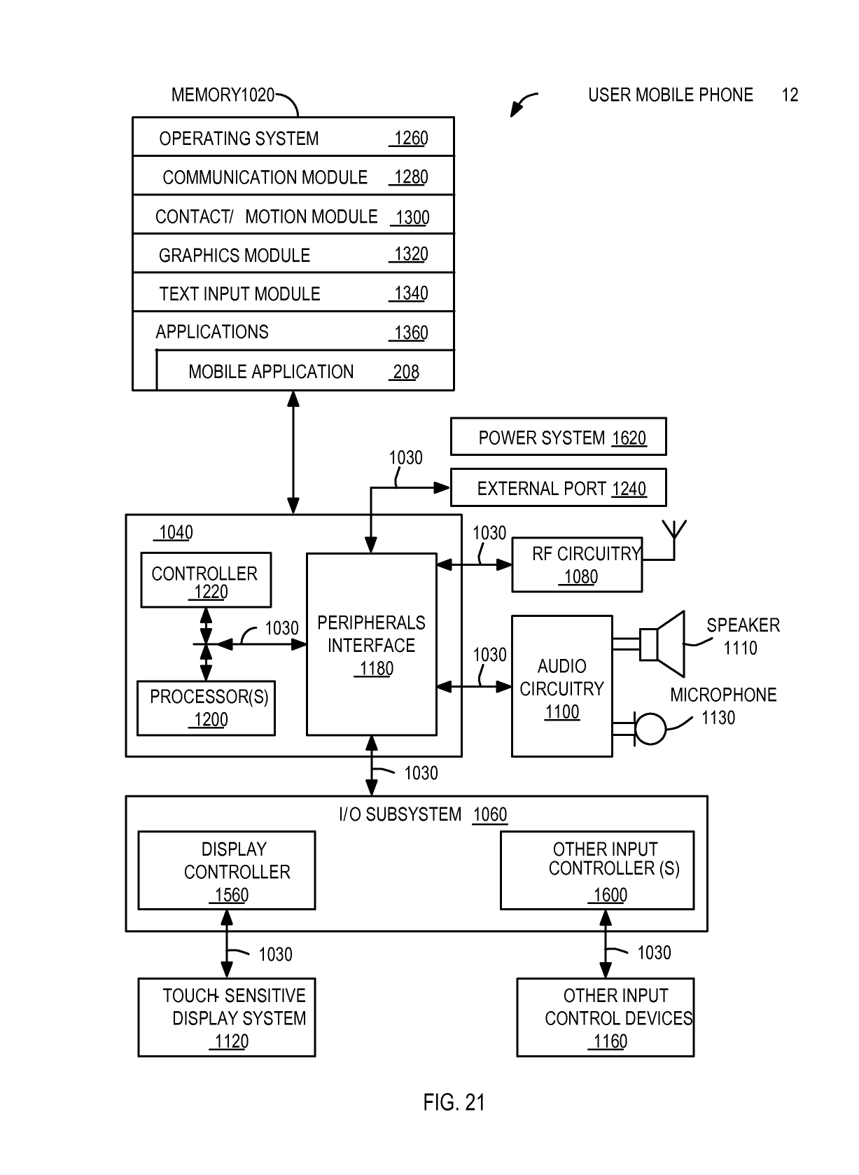

FIG. 21 is a block diagram illustrating the user mobile phone 12, illustrating a touch-sensitive display 1120 or a “touch screen” for convenience. The user mobile phone 12 includes a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 21 may be implemented in hardware, software or a combination of hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the user mobile phone 12, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the user mobile phone 12 and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the user mobile phone 12. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the user mobile phone 12, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the user mobile phone 12 on or off. The touch screen 1120 is used to implement virtual or soft buttons and one or more soft keyboards.

The touch-sensitive touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The user mobile phone 12 also includes a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), FIREWIRE, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include the mobile application 208.

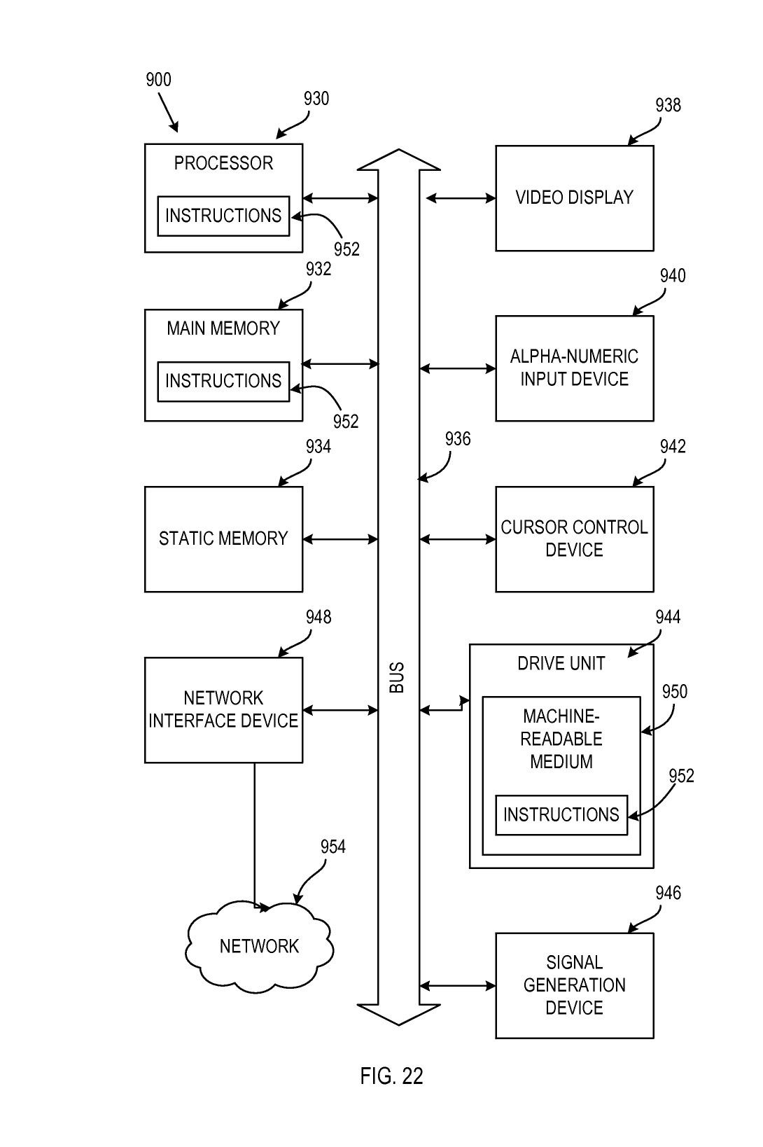

FIG. 22 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of processing a sale of an article, a virtual article, a service, or a functionality comprising:
receiving, with the billing server, a request message from a mobile application running on the user device, the request message being a request for a code;
transmitting, with billing server, a charge request to an account server to charge an account of a user for a value of the code, the charge request being in response to the request message; and
transmitting, with the billing server, the code to a user device of the user.

2. The method of claim 1, further comprising:
processing, with the a merchant server, a redemption of the code, wherein the redemption includes receiving the code from a user device of the user and in response allowing access to the user device to the article, virtual article, service, or functionality.

3. The method of claim 1, further comprising:
synchronizing, with a billing server, the code with a merchant server.

4. The method of claim 3, further comprising:
receiving, with the billing server, payment from the account server in response to the charge request; and
transmitting, with the billing server, a payment to the merchant server in response to receiving the payment from the account server.

5. The method of claim 3, wherein the billing server receives the code from the merchant server before the account has been charged.

6. The method of claim 5, wherein a plurality of codes are received before the account has been charged.

7. The method of claim 1, further comprising:
identifying, with the billing server, a carrier server of the user from a plurality of carrier servers, wherein the account server is the carrier server; and
receiving, with the billing server, a phone number of the user, the account being an account identified by the phone number on the carrier server.

8. The method of claim 1, further comprising:
transmitting, with the billing server, a first text message to the user device in response to the request message, the first text message requesting an authorization to charge the account; and
receiving, with the billing server, a second text message from the user device in response to the first text message, the second text message indicating either authorization or not authorization, the charge request only being transmitted if the second text message indicates authorization.

9. The method of claim 8, further comprising:
identifying, with the billing server, a carrier server of the user from the second text message, wherein the account server is the carrier server.

10. The method of claim 1, further comprising:
receiving, with the billing server, a confirmation from the account server that the account has been charged; and
transmitting, with the billing server, a billing result to a merchant server in response to receiving the confirmation, wherein the merchant server transmits the code to the user device and the user device is redeemed at the merchant server.

11. A billing server comprising:
a processor;
a computer-readable medium connected to the processor;
a network interface device connected to the processor; and
a set of instructions on the computer-readable medium being executable by the processor to carry out a method for processing a sale of an article, a virtual article, a service, or a functionality including:
a mobile application communication module receiving a request message from a mobile application running on the user device, the request message being a request for a code;
a billing module transmitting a charge request to an account server to charge an account of a user for a value of the code, the charge request being in response to the request message; and
a code management module transmitting the code to a user device of the user.

12. A method of processing a sale of an article, a virtual article, a service, or a functionality comprising:
receiving, with the billing server, a phone number and a code from a merchant server;
transmitting, with billing server, a charge request to an account server to charge an account of a user for a value of the code, the charge request being in response to receiving the phone number at the billing server; and
transmitting, with the billing server, the code to a user device of the user.

13. The method of claim 12, further comprising:
processing, with the a merchant server, a redemption of the code, wherein the redemption includes receiving the code from a user device of the user and in response allowing access to the user device to the article, virtual article, service, or functionality.

14. The method of claim 12, further comprising:
synchronizing, with a billing server, the code with a merchant server.

15. The method of claim 14, further comprising:
receiving, with the billing server, payment from the account server in response to the charge request; and
transmitting, with the billing server, a payment to the merchant server in response to receiving the payment from the account server.

16. The method of claim 14, wherein the billing server receives the code from the merchant server before the account has been charged.

17. The method of claim 16, wherein a plurality of codes are received before the account has been charged.

18. The method of claim 12, further comprising:
identifying, with the billing server, a carrier server of the user from a plurality of carrier servers, wherein the account server is the carrier server; and
the account being an account identified by the phone number on the carrier server.

19. The method of claim 12, further comprising:
transmitting, with the billing server, a first text message to the user device in response to the request message, the first text message requesting an authorization to charge the account; and
receiving, with the billing server, a second text message from the user device in response to the first text message, the second text message indicating either authorization or not authorization, the charge request only being transmitted if the second text message indicates authorization.

20. The method of claim 19, further comprising:
identifying, with the billing server, a carrier server of the user from the second text message, wherein the account server is the carrier server.

21. The method of claim 12, further comprising:
receiving, with the billing server, a confirmation from the account server that the account has been charged; and
transmitting, with the billing server, a billing result to a merchant server in response to receiving the confirmation, wherein the merchant server transmits the code to the user device and the user device is redeemed at the merchant server.

22. A billing server comprising:
a processor;
a computer-readable medium connected to the processor;
a network interface device connected to the processor; and
a set of instructions on the computer-readable medium being executable by the processor to carry out a method for processing a sale of an article, a virtual article, a service, or a functionality including:
a billing server application programmable interface receiving a phone number and a code from a merchant server;
a billing module transmitting a charge request to an account server to charge an account of a user for a value of the code, the charge request being in response to receiving the phone number at the billing server; and
a code management module transmitting the code to a user device of the user.

23. A method of processing a sale of an article, a virtual article, a service, or a functionality comprising:
receiving, with a billing server, a request message via a payment panel of the billing server on a website of a merchant server, the request message including a phone number and being a request for a code;
transmitting, with billing server, a charge request to an account server to charge an account of a user for a value of the code, the charge request being in response to the request message; and
transmitting, with the billing server, the code to a user device of the user.

24. The method of claim 23, further comprising:
processing, with the merchant server, a redemption of the code, wherein the redemption includes receiving the code from a user device of the user and in response allowing access to the user device to the article, virtual article, service, or functionality.

25. The method of claim 23, further comprising:
synchronizing, with a billing server, the code with a merchant server.

26. The method of claim 25, further comprising:
receiving, with the billing server, payment from the account server in response to the charge request; and
transmitting, with the billing server, a payment to the merchant server in response to receiving the payment from the account server.

27. The method of claim 25, wherein the billing server receives the code from the merchant server before the account has been charged.

28. The method of claim 27, wherein a plurality of codes are received before the account has been charged.

29. The method of claim 23, further comprising:
identifying, with the billing server, a carrier server of the user from a plurality of carrier servers, wherein the account server is the carrier server; and
the account being an account identified by the phone number on the carrier server.

30. The method of claim 23, further comprising:
receiving, with the billing server, a payment panel request from the merchant server; and
transmitting, with the billing server, the payment panel to the merchant server in response to the payment panel request.

31. The method of claim 23, further comprising:
transmitting, with the billing server, a first text message to the user device in response to the request message, the first text message requesting an authorization to charge the account;
receiving, with the billing server, a second text message from the user device in response to the first text message, the second text message indicating either authorization or not authorization, the charge request only being transmitted if the second text message indicates authorization; and
identifying, with the billing server, a carrier server of the user from the second text message, wherein the account server is the carrier server.

32. The method of claim 23, further comprising:
receiving, with the billing server, a confirmation from the account server that the account has been charged; and
transmitting, with the billing server, a billing result to a merchant server in response to receiving the confirmation, wherein the merchant server transmits the code to the user device and the user device is redeemed at the merchant server.

33. A billing server comprising:
a processor;
a computer-readable medium connected to the processor;
a network interface device connected to the processor; and
a set of instructions on the computer-readable medium being executable by the processor to carry out a method for processing a sale of an article, a virtual article, a service, or a functionality including:
a payment panel communication module receiving a request message via a payment panel of the billing server on a website of a merchant server, the request message including a phone number and being a request for a code;
a billing module transmitting a charge request to an account server to charge an account of a user for a value of the code, the charge request being in response to the request message; and
a code management module transmitting the code to a user device of the user.
